(19) United States
(12) Patent Application Publication
(10) Pub. No.: US 2008/0294747 A1
(43) Pub. Date: Nov. 27, 2008

(54) Property billboarding and financial revenue distribution to property owner in a geo-spatial environment

(75) Inventor: Raj Vasant Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/805,329

(22) Filed: May 22, 2007

(51) Int. Cl. G06F 15/16

(52) U.S. Cl. 709/218

(57) ABSTRACT

A method, apparatus and system of property billboarding and financial revenue distribution to property owner in a geo-spatial environment are disclosed. In one embodiment, a method includes generating a community network of user profiles, each user profile of the user profiles associated with a specific geographic location, determining a first user profile of the user profiles, generating advertisements, determining a first advertisement of the advertisements, generating a first display view to include a three-dimensional map view embodied by the community network, the first user profile of the user profiles represented at a location in the three-dimensional map view corresponding with the associated specific geographic location, and the first advertisement of the advertisements displayed in conjunction with the first user profile of the user profiles, and generating a commerce transaction associated with the first user profile of the user profiles.

### FIELD OF TECHNOLOGY

This disclosure relates generally to the technical field of communications, and in one embodiment, to a method, system and apparatus of property billboarding and financial revenue distribution to property owner in a geo-spatial environment.

### BACKGROUND

Billboarding may be used to promote products and/or services. Advertisements are sometimes displayed on buildings and/or other structures. For example, advertisers may pay building owners to display the advertisements on faces of city buildings, barns, etc. The advertisements may provide a promotional profile sought by the advertisers and may generate revenue sought by the building owners. Sometimes, however, local ordinances may prohibit advertising in the form of billboarding.

Billboarding may also be found in a geo-spatial environment. For example, sponsors of geo-spatial environments may display the advertisements on representations of real life buildings and/or structures. The advertisers may pay the sponsors of the geo-spatial environments for the billboarding services. Owners of the buildings and/or structures represented in the geo-spatial environment, however, may not receive any compensation for the advertisements displayed in conjunction with the representations.

### SUMMARY OF THE DISCLOSURE

A method, apparatus and system of property billboarding and financial revenue distribution to property owner in a geo-spatial environment are disclosed. In one aspect, a method includes generating a community network of user profiles, each user profile associated with a specific geographic location, determining a first user profile, generating advertisements, determining a first advertisement, generating a first display view to include a three-dimensional map view embodied by the community network, the first user profile represented at a location in the three-dimensional map view corresponding with the associated specific geographic location, and the first advertisement displayed in conjunction with the first user profile, and generating a commerce transaction associated with the first user profile.

The first advertisement may also be displayed in conjunction with a property representation selected from a group including a representation of an outside surface of a structure associated with the first user profile, a representation of an inside area of a structure associated with the first user profile, a representation of an outside property area associated with the first user profile, a wiki associated with the first user profile, and content associated with the wiki.

The method may further include generating a revenue transaction associated with the first user profile. The method may also include generating an online payment transaction associated with the first user profile. The method may include generating a link between the first advertisement and a website, tabulating clicks of the link, determining revenue based on the tabulation of the clicks, and generating the online payment transaction associated with the first user profile based on the revenue.

In addition, the method may include apportioning a first portion of the revenue and a second portion of the revenue associated with the online payment transaction, associating the first portion of the revenue with a claimant of the first user profile, and associating the second portion of the revenue with a sponsor of the community network.

The method may include providing at least a portion of the advertisements available for placement in conjunction with a particular user profile. The method may further include providing at least a portion of the user profiles available to accept an advertisement. In addition, the method may include selecting a geographic region, and selecting a particular user profile of the portion of the user profiles available to accept an advertisement having a specific geographic location associated with the geographic region.

The method may also include receiving a preference (e.g., may include an advertiser, a product, and/or a service) associated with a second user profile of the portion of the user profiles available to accept an advertisement, determining a second advertisement that matches the preference, and generating a second display view to include a three-dimensional map view embodied by the community network, the second user profile represented at a location in the three-dimensional map view corresponding with the associated specific geographic location, and the second advertisement displayed in conjunction with the second user profile.

The method may further include providing search categories associated with the advertisements, selecting at least one search category, determining a third advertisement associated with the search category, determining a third user profile associated with the third advertisement, and generating a third display view to include a three-dimensional map view embodied by the community network, the third user profile represented at a location in the three-dimensional map view corresponding with the associated specific geographic location, and the third advertisement displayed in conjunction with the third user profile.

The search categories may include a preference, a location of a user profile, and/or a type of advertisement (e.g., may be associated with a product, a service, an event, a celebrity, and/or content such as music clips, movie trailers, audiovisual clips and/or podcasts, etc.). In addition, the method may include generating a link between the third advertisement and a website, selecting the link, and generating an online transaction associated with the third advertisement. The online transaction may further include generating an online purchase transaction associated with the product and/or the service. The online transaction may also include generating an online order of music associated with the music clip.

Moreover, the online transaction may include generating an online order of a movie associated with the movie trailer. The online transaction may also include generating an online reservation associated with the event, and generating an online payment transaction associated with the online reservation. Furthermore, the online transaction may include generating a link associated with the celebrity.

In another aspect, a system includes a geo-spatial environment, a community network module of the geo-spatial environment to include user profiles, each user profile to include a specific geographic location, an advertisement module of the geo-spatial environment to generate advertisements, a map module of the geo-spatial environment to include map data which serves as a basis to render a three-dimensional map view in the geo-spatial environment which identifies residences, businesses, and/or civic structures having specific geographic locations, a display module of the geo-spatial environment to generate a first display view of the three-dimensional map view embodied by the community network, a first user profile represented at a location in the three-dimensional map view corresponding to the specific geographic location associated with the first user profile, and an advertisement displayed in conjunction with the first user profile, and a commerce transaction module of the geo-spatial environment to generate a commerce transaction associated with the first user profile.

The system may further include a revenue module of the geo-spatial environment to generate revenue associated with the commerce transaction. The system may also include an online payment transaction module of the geo-spatial environment to generate an online payment transaction associated with the revenue (e.g., a first portion of the revenue may be associated with a claimant of the first user profile and a second portion of the revenue may be associated with a sponsor of the community network).

The system may also include a tabulate module of the geo-spatial environment to generate a link associated with the first advertisement, to tabulate clicks of the link, and to associate the tabulated links with the commerce transaction. The system may yet include an availability module of the geo-spatial environment to provide a portion of the user profiles available to accept advertisements and to enable selection of a particular user profile of the portion of user profiles with which a particular advertisement is associated.

Moreover, the system may include a preference module of the geo-spatial environment to determine a second profile available to accept an advertisement, to receive a preference (e.g., may include an advertiser, a product, and/or a service) associated with the second user profile available to accept an advertisement, and to determine a particular advertisement that matches the preference. The system may also include a search module of the geo-spatial environment to provide search categories (e.g., may include preferences, locations of user profiles, and/or types of advertisements), to enable selection of at least one search category, to determine at least one advertisement associated with a selected search category, and to identify at least one user profile associated with the advertisement.

The system may further include a wiki profile module of the geo-spatial environment to generate a wiki profile associated with at least one representation of a user profile. The system may also include an append module of the geo-spatial environment to generate, with the wiki profile, content associated with the wiki profile.

In yet another aspect, a geo-spatial environment includes a first instruction set to enable a community network to include a map database associated with map data, a user database associated with user profiles, each user profile associated with a specific geographic location identifiable in the map data, and an advertisement database associated with advertisements, each advertisement associated with a user profile. The system also includes a second instruction set integrated with the first instruction set to display a three-dimensional map view embodied by the community network, a user profile represented at a location in the three-dimensional map view corresponding to the associated specific geographic location and an advertisement associated with the user profile. The system further includes a third instruction set to generate a commerce transaction associated with the user profile.

The geo-spatial environment may include a fourth instruction set to generate an online payment transaction associated with the user profile. The geo-spatial environment may also include a fifth instruction set to provide at least a portion of the user profiles available to accept an advertisement, and a sixth instruction set to provide search categories, to enable selection of at least one search category, to determine at least one advertisement associated with a selected search category, and to identify at least one user profile associated with the advertisement.

The methods, systems, and apparatus disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a geo-spatial environment communicating with users through a network, according to one embodiment.

FIG. 2 is an exploded view of the community network module of FIG. 1, according to one embodiment.

FIG. 3 is an exploded view of the additional modules of FIG. 1, according to one embodiment.

FIG. 4 is a block diagram illustrating generation of a display view associated with the advertisements, according to one embodiment.

FIG. 5 is a block diagram representation of search categories, according to one embodiment.

FIG. 6 is a user interface view displaying profile details of a user associated with the community network, according to one embodiment.

FIG. 7 is a user interface view of property billboarding associated with a specific geographic location, according to one embodiment.

FIG. 8 is a user interface view of listing property of the user as available to accept an advertisement, according to one embodiment.

FIG. 9 is a user interface view of the property billboarding preview, according to one embodiment.

FIG. 10 is a user interface view of listing an advertisement for placement in the geo-spatial environment, according to one embodiment.

FIG. 11 is a user interface view of a search menu associated with the property billboarding, according to one embodiment.

FIG. 12 is a user interface view displaying search results associated with the property billboarding, according to one embodiment.

FIG. 13 is a representation of the displayed advertisements, according to one embodiment.

FIG. 14 is a table view displaying advertisement and commerce transaction information, according to one embodiment.

FIG. 15 is a diagrammatic system view of a data processing system in which any of the embodiments disclosed herein may be performed, according to one embodiment.

FIG. 16A is a process flow of generating a commerce transaction associated with a user profile in the geo-spatial environment, according to one embodiment.

FIG. 16B is a continuation of the process flow of FIG. 16A, showing additional processes, according to one embodiment.

FIG. 16C is a continuation of the process flow of FIG. 16B, showing additional processes, according to one embodiment.

FIG. 16D is a continuation of the process flow of FIG. 16C, showing additional processes, according to one embodiment.

FIG. 16E is a continuation of the process flow of FIG. 16D, showing additional processes, according to one embodiment.

Other features of the present embodiments will be apparent from the accompanying drawings and from the detailed description that follows.

### DETAILED DESCRIPTION

A method, system and apparatus of property billboarding and financial revenue distribution to property owner in a geo-spatial environment are disclosed. In the following description, for the purposes of explanation, numerous specific details are set forth in order to provide a thorough understanding of the various embodiments. It will be evident, however, to one skilled in the art that the various embodiments may be practiced without these specific details.

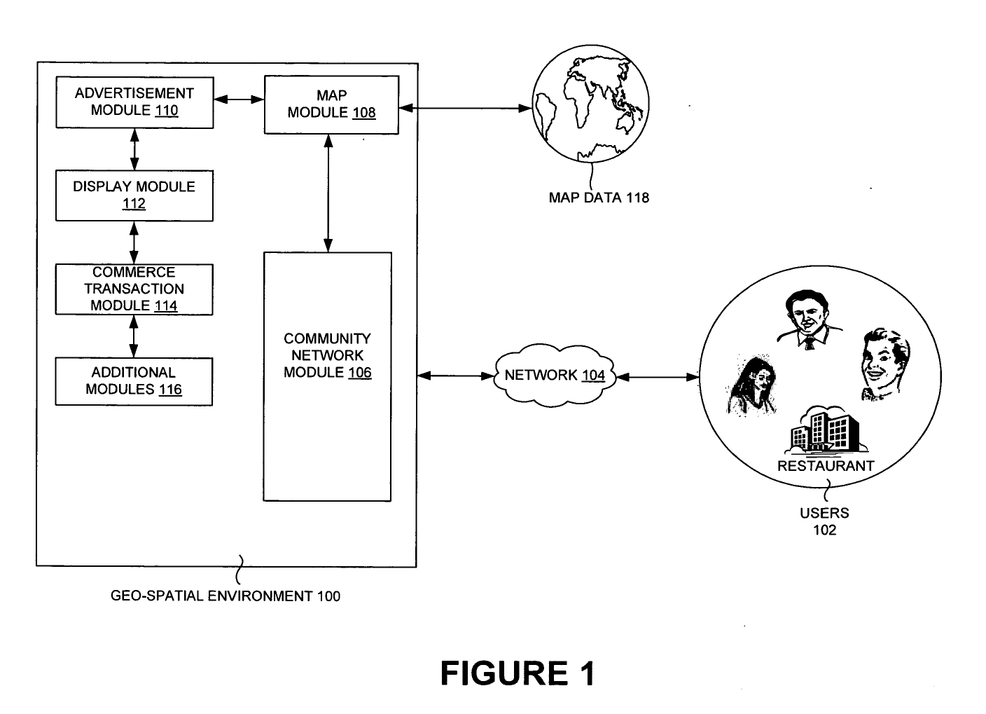

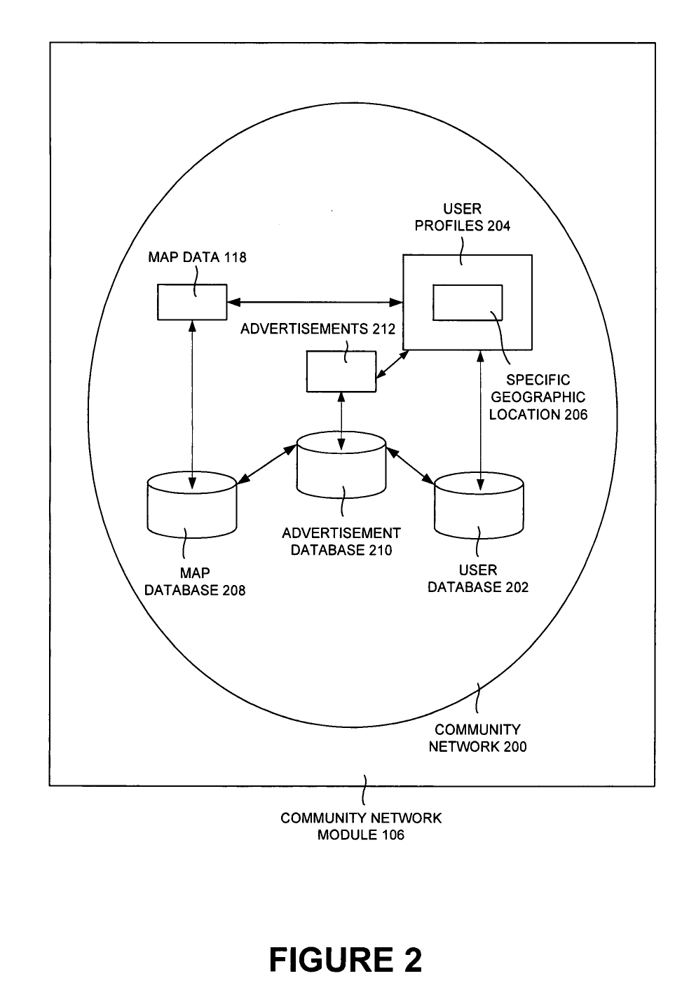

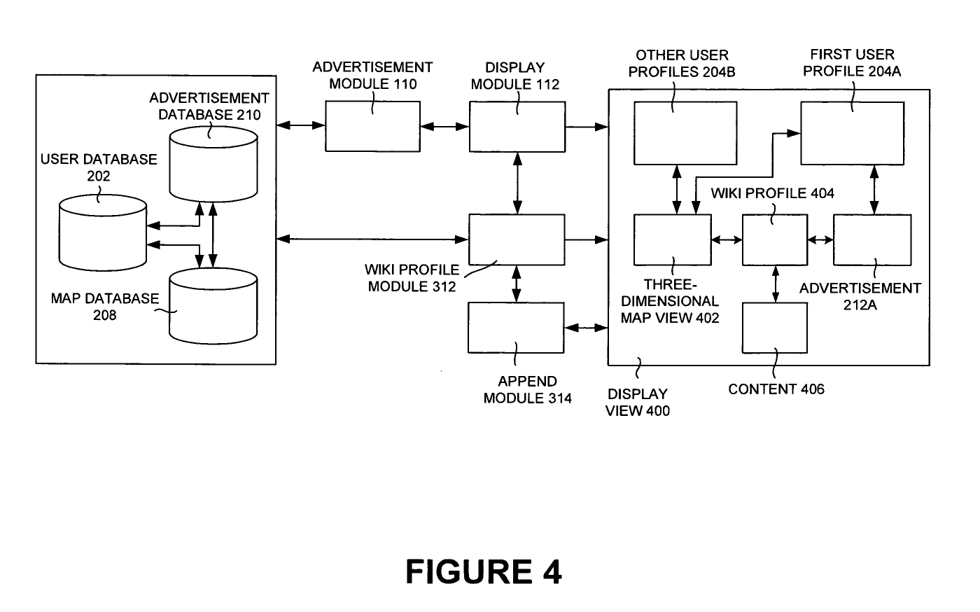

In one embodiment, a method includes generating a community network (e.g., the community network 200 of FIG. 2) of user profiles (e.g., the user profiles 204 of FIG. 2), each user profile associated with a specific geographic location (e.g., the specific geographic location 206 of FIG. 2), determining a first user profile (e.g., the first user profile 204A of FIG. 4), generating advertisements (e.g., the advertisements 212 of FIG. 2), determining a first advertisement (e.g., the advertisement 212A of FIG. 4), generating a first display view (e.g., the display view 400 of FIG. 4) to include a three-dimensional map view (e.g., the three-dimensional map view 402 of FIG. 4) embodied by the community network 200, the first user profile 204A represented at a location in the three-dimensional map view 402 corresponding with the associated specific geographic location 206, and the first advertisement displayed (e.g., using the display module 112 of FIG. 1) in conjunction with the first user profile 204A, and generating a commerce transaction (e.g., through the commerce transaction module 114 of FIG. 1) associated with the first user profile 204A.

In another embodiment, a system includes a geo-spatial environment (e.g., the geo-spatial environment 100 of FIG. 1), a community network module (e.g., the community network module 106 of FIG. 1) of the geo-spatial environment 100, to include user profiles (e.g., the user profiles 204 of FIG. 2), each user profile to include a specific geographic location (e.g., the specific geographic location 206 of FIG. 2), and an advertisement module (e.g., the advertisement module 110 of FIG. 1) of the geo-spatial environment 100 to generate advertisements 212. The system also includes a map module (e.g., the map module 108 of FIG. 1) of the geo-spatial environment 100 to include map data (e.g., the map data 118 of FIG. 1) which serve as a basis to render a three-dimensional map view (e.g., the three-dimensional map view 402 of FIG. 4) in the geo-spatial environment 100 which identifies residences, businesses, and/or civic structures having specific geographic locations a display module (e.g., the display module 112 of FIG. 1) of the geo-spatial environment 100 to generate a first display view (e.g., the display view 400 of FIG. 4) of the three-dimensional map view 402 embodied by a community network (e.g., the community network 200 of FIG. 2), a first user profile (e.g., the first user profile 204A of FIG. 4) represented at a location in the three-dimensional map view 402 corresponding to the specific geographic location 206 associated with the first user profile 204A, and an advertisement displayed in conjunction with the first user profile 204A, and a commerce transaction module (e.g., the commerce transaction module 114 of FIG. 1) of the geo-spatial environment 100 to generate a commerce transaction associated with the first user profile 204A.

In yet another embodiment, a geo-spatial environment (e.g., the geo-spatial environment 100 of FIG. 1) includes a first instruction set to enable a community network (e.g., the community network 200 of FIG. 2), to include a map database (e.g., the map database 208 of FIG. 2) associated with map data (e.g., the map data 118 of FIG. 1), a user database (e.g., the user database 202 of FIG. 2) associated with user profiles (e.g., the user profiles 204 of FIG. 2), each user profile 204 associated with a specific geographic location (e.g., the specific geographic location 206 of FIG. 2) identifiable in the map data 118, and an advertisement database (e.g., the advertisement database 210 of FIG. 2) associated with advertisements 212, each advertisement 212 associated with a user profile 204, a second instruction set integrated with the first instruction set to display a three-dimensional map view (e.g., the three-dimensional map view 402 of FIG. 4) embodied by the community network 200, a user profile 204 represented at a location in the three-dimensional map view 402 corresponding to the associated specific geographic location 206, and an advertisement 212 associated with the user profile 204, and a third instruction set to generate a commerce transaction associated with the first user profile 204A.

FIG. 1 is a system view of a geo-spatial environment 100 communicating with users 102 through a network 104, according to one embodiment. Particularly, FIG. 1 illustrates the geo-spatial environment 100, the users 102, the network 104, a community network module 106, a map module 108, an advertisement module 110, a display module 112, a commerce transaction module 114, additional modules 116 and map data 118, according to one embodiment.

The geo-spatial environment 100 may consist of advertisements (e.g., the advertisements 212 of FIG. 2) displayed in conjunction with representation of buildings and/or structures associated with user profiles (e.g., the user profiles 204 of FIG. 2). The users 102 may be entities (e.g., individuals, commercial structures, etc.) having user profiles 204 associated with a specific geographic location (e.g., the specific geographic location 206 of FIG. 2) in the geo-spatial environment 100. The network 104 may enable property billboarding and financial revenue distribution between the users 102 in the geo-spatial environment 100.

The community network module 106 may generate a community network (e.g., the community network 200 of FIG. 2) with the user profiles 204 associated with the specific geographic location 206. The map module 108 may generate a three-dimensional map view (e.g., the three-dimensional map view 402 of FIG. 4) which includes residences, businesses and/or civic structures having specific geographic locations 206. The advertisement module 110 may generate the advertisements 212 that are displayed along with the user profiles 204 in the geo-spatial environment 100. The display module 112 may display the advertisements 212 along with the user profiles 204 in the three-dimensional map view 402.

The commerce transaction module 114 may generate a commerce transaction associated with the property billboarding in the geo-spatial environment 100. The additional modules 116 may generate additional processes associated with the property billboarding in the geo-spatial environment 100. The map data 118 may be address data and/or location data associated with the user profiles 204, that serve as a basis to render the three-dimensional map view 402.

In the example embodiment illustrated in FIG. 1, the geo-spatial environment 100 communicates with the users 102 through the network 104. The geo-spatial environment 100 consists of the community network module 106, the map module 108, the advertisement module 110, the display module 112, the commerce transaction module 114, and the additional modules 116, that communicate with each other. The map module 108 also processes (e.g., generates, tracks, captures, stores and/or analyzes, etc.) the map data 118.

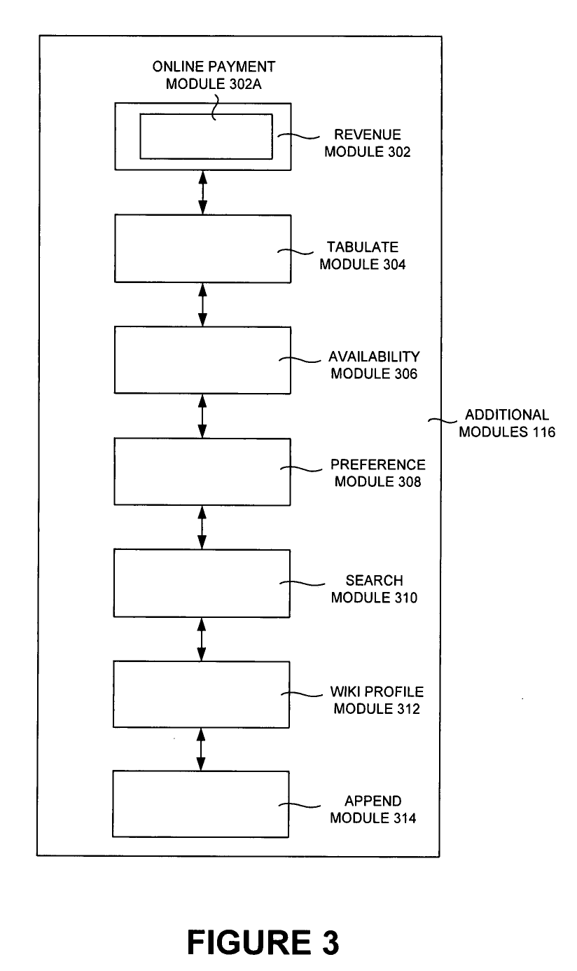

A portion of the advertisements 212 available for placement in conjunction with a particular user profile 204 and a portion of the user profiles 204 available to accept an advertisement 212 may be provided (e.g., using the advertisement module 110 of FIG. 1 and/or the availability module 306 of the FIG. 3). A geographic region may be selected, and/or a particular user profile 204 (e.g., of the portion of the user profiles 204 available to accept an advertisement 212) having a specific geographic location (e.g., the specific geographic location 206 of FIG. 2) associated with the geographic region may be selected.

The geo-spatial environment 100 may include the community network module 106, to include user profiles 204, each user profile 204 to include the specific geographic location 206. The advertisement module 110 of the geo-spatial environment 100 may process (e.g., generate) the advertisements 212. The map module 108 of the geo-spatial environment 100 may include the map data 118 which serves as a basis to render the three-dimensional map view 402 in the geo-spatial environment 100 which identifies the residences, the businesses, and/or the civic structures having the specific geographic locations 206.

The display module 112 of the geo-spatial environment 100 may generate a first display view (e.g., the display view 400 of FIG. 4) of the three-dimensional map view 402 embodied by the community network 200, a first user profile (e.g., the first user profile 204A of FIG. 4) represented at a location in the three-dimensional map view 402 corresponding to the specific geographic location 206 associated with the first user profile 204A, and an advertisement 212 displayed in conjunction with the first user profile 204A.

The commerce transaction module 114 of the geo-spatial environment 100 may generate a commerce transaction associated with the first user profile 204A (e.g., an online purchase). The geo-spatial environment 100 may include a third instruction set to generate the commerce transaction associated with the user profiles 204. The geo-spatial environment 100 may include a fifth instruction set to provide the portion of the user profiles 204 available to accept an advertisement 212.

FIG. 2 is an exploded view of the community network module 106 of FIG. 1, according to one embodiment. Particularly, FIG. 2 illustrates the map data 118, a community network 200, a user database 202, user profiles 204, a specific geographic location 206, a map database 208, an advertisement database 210, and advertisements 212, according to one embodiment.

The community network 200 may enable association of the advertisements 212 with the user profiles 204 in the geo-spatial environment 100. The user database 202 may generate the user profiles 204 in the geo-spatial environment 100. The specific geographic location 206 may be a geographic region associated with the user profiles 204 and/or the advertisements 212 (e.g., in the geospatial environment 100). The map database 208 may generate the map data 118 which serves as the basis to render the three-dimensional map view 402 in the geo-spatial environment 100.

The advertisement database 210 may generate the advertisements 212 that are displayed along with the user profiles 204 in the geo-spatial environment 100. The advertisements 212 may be associated with products and/or services used for publicity, sales promotion, and/or product placement through different media.

In the example embodiment as illustrated in FIG. 2, the community network module 106 consists of the community network 200 that includes the user database 202, the map database 208, and the advertisement database 210, from which the user profiles 204, the map data 118, and the advertisements 212 associated with the specific geographic location 206 are generated.

The community network 200 of the user profiles 204 may be generated (e.g., by the community network module 106 of FIG. 1) Each user profile 204 may be associated with a specific geographic location 206, and/or the first user profile 204A may be determined. The advertisements 212 may be generated and/or a first advertisement (e.g., the first advertisement 212A of FIG. 4) of the advertisements 212 may be determined (e.g., using the advertisement module 110 of FIG. 1). The geo-spatial environment 100 may include a first instruction set to enable the community network 200 to include the map database 208 associated with the map data 118, the user database 202 associated with user profiles 204, each user profile 204 associated with a specific geographic location 206 identifiable in the map data 118, and the advertisement database 210 associated with the advertisements 212, each advertisement 212 associated with a user profile 204.

FIG. 3 is an exploded view of the additional modules 116 of FIG. 1, according to one embodiment. Particularly, FIG. 3 illustrates a revenue module 302, an online payment module 302A, a tabulate module 304, an availability module 306, a preference module 308, a search module 310, a wiki profile module 312, and an append module 314, according to one embodiment.

The revenue module 302 may process (e.g., generate, capture, track, store and/or synchronize) revenue based on transactions involved in the property billboarding in the geo-spatial environment 100. The online payment module 302A may process monetary transactions associated with the property billboarding. The tabulate module 304 may generate a link associated with an advertisement 212 and may also tabulate (e.g., record, track and/or analyze, etc.) clicks of the link based on which the commerce transaction is performed. The availability module 306 may provide user profiles 204 ready to accept the advertisements 212 in the geo-spatial environment 100.

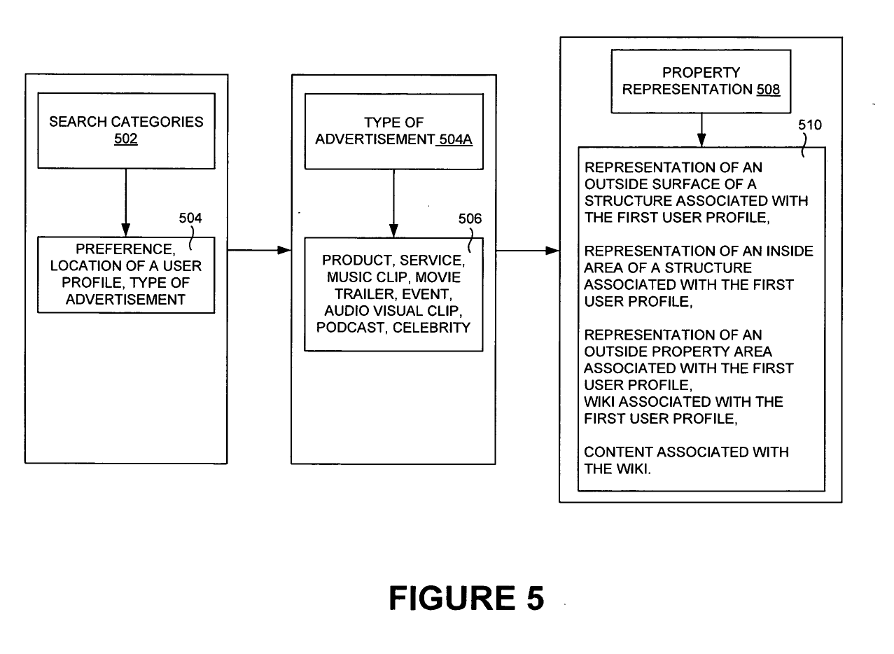

The preference module 308 may associate a particular advertisement 212 with a user profile 204 based on a preference of the user profile 204. The search module 310 may provide search categories (e.g., the search categories 502 of FIG. 5) to enable selection of desired advertisements 212 to place them along with the user profiles 204 in the geo-spatial environment 100. The wiki profile module 312 may generate wiki profiles (e.g., the wiki profiles 404 illustrated in FIG. 4) associated with the user profiles 204 in the geo-spatial environment 100. The append module 314 may generate content (e.g., comments, feedback, ratings, flags, etc.) added to the wiki profiles 404 by the users 102 of the geo-spatial environment 100.

In the example embodiment illustrated in FIG. 3, the additional modules 116 include the revenue module 302, the online payment module 302A, the tabulate module 304, the availability module 306, the preference module 308, the search module 310, the wiki profile module 312, and the append module 314, communicating with each other.

A revenue transaction associated with a first user profile 204A may be generated (e.g., based on a property billboarding activity of a user 102 in the geo-spatial environment 100) through the revenue module 302, based on which an online payment transaction associated with the first user profile 204A may be generated (e.g., by the online payment module 302A). A preference (e.g., may include an advertiser, a product, and/or a service) associated with a second user profile 204 available to accept an advertisement 212 may be received from a user 102, and/or a second advertisement 212 that matches the preference may be determined. A second display view may be generated to include a three-dimensional map view (e.g., the three-dimensional map view 402 of FIG. 4) embodied by the community network 200, the second user profile 204 represented at a location in the three-dimensional map view 402 corresponding with the associated specific geographic location 206, and the second advertisement 212 displayed in conjunction with the second user profile 204.

The revenue module 302 of the geo-spatial environment 100 may generate the revenue (e.g., a first portion of the revenue may be associated with a claimant of the first user profile 204A and a second portion of the revenue may be associated with a sponsor of the community network 200) associated with the commerce transaction. The online payment module 302A of the geo-spatial environment 100 may generate an online payment transaction associated with the revenue. The tabulate module 304 of the geo-spatial environment 100 may generate the link associated with the advertisement 212, to tabulate clicks of the link, and to associate the tabulated links with the commerce transaction.

The availability module 306 of the geo-spatial environment 100 may process (e.g., determine) a portion of the user profiles 204 available to accept the advertisements 212, and/or may enable selection of a particular user profile 204 with which a particular advertisement 212 is associated. The preference module 308 of the geo-spatial environment 100 may determine the second user profile 204 available to accept an advertisement, 212 to receive the preference (e.g., may include advertiser, product, and/or service) associated with the second user profile 204 available to accept an advertisement 212, and to determine a particular advertisement 212 that matches the preference.

The search module 310 of the geo-spatial environment 100 may provide the search categories 502 (e.g., may include preference, location of a user profile, and/or type of advertisement) to enable selection of a search category (e.g., the search categories 502 illustrated in FIG. 5), to determine an advertisement 212 associated with a selected search category 502, and to identify a user profile 204 associated with the advertisement 212. The wiki profile module 312 of the geo-spatial environment 100 may generate a wiki profile (e.g., the wiki profile 404 of FIG. 4) associated with a representation of a user profile 204. The append module 314 of the geo-spatial environment 100 may generate, with the wiki profile 404, content associated with the wiki profile 404 (e.g., the content 406 of FIG. 4). The geo-spatial environment 100 may include a fourth instruction set to generate an online payment transaction associated with the user profile 204 (e.g., using the online payment module 302A of FIG. 3).

FIG. 4 is a block diagram illustrating generation of a display view 400 associated with the advertisements 212, according to one embodiment. Particularly, FIG. 4 illustrates the advertisement module 110, the display module 112, the user database 202, a first user profile 204A, other user profiles 204B, the map database 208, the advertisement database 210, an advertisement 212A, the wiki profile module 312, the append module 314, the display view 400, a three-dimensional map view 402, a wiki profile 404, and a content 406, according to one embodiment.

The display view 400 may display the advertisements 212 in conjunction with the user profiles 204 in the three-dimensional map view 402. The three-dimensional map view 402 may enable the users 102 of the geo-spatial environment 100 to visualize the advertisements 212 in their neighborhood. The wiki profile 404 may be a profile associated with a user 102 (e.g., the user profiles 204 of FIG. 2) that is represented in the three-dimensional map view 402. The content 406 may be comments that are added to the wiki profile 404 by the users 102 of the geo-spatial environment 100.

In the example embodiment as illustrated in FIG. 4, the display view 400 includes the three-dimensional map view 402 and the advertisement 212A associated with the first user profile 204A. The advertisements 212 generated from the advertisement database 210 may be displayed in conjunction with the user profiles 204 in the display view 400. The wiki profile 404 and the other user profiles 204B (e.g., generated from the user database 202) are also displayed in the display view 400 along with the advertisements 212.

The first display view may be generated to include the three-dimensional map view 402 embodied by the community network 200, the first user profile 204A represented at a location in the three-dimensional map view 402 corresponding with the associated specific geographic location 206, and the first advertisement 212 displayed in conjunction with the first user profile 204A. The commerce transaction associated with the first user profile 204A may be generated (e.g., through the commerce transaction module 114 of FIG. 1).

A link between the first advertisement 212A and a website may be generated, and/or clicks of the link may be tabulated (e.g., using the tabulate module 304 of FIG. 3). A revenue factor (e.g., amount, distribution, etc.) may be determined based on the tabulation of the clicks (e.g., on a cost-per-click (CPC) basis), using the revenue module 302 of FIG. 3). The online payment transaction associated with the first user profile 204A may be generated based on the revenue factor (e.g., by the online payment module 302A of the revenue module 302 of FIG. 3). The first portion of the revenue and the second portion of the revenue associated with the online payment transaction may be apportioned, and/or the first portion of the revenue may be associated with the claimant of the first user profile 204A.

The second portion of the revenue may be associated with the sponsor of the community network 200. The geo-spatial environment 100 may include a second instruction set integrated with the first instruction set to display the three-dimensional map view 402 embodied by the community network 200, a user profile 204 represented at a location in the three-dimensional map view 402 corresponding to the associated specific geographic location 206, and an advertisement 212 associated with the user profile 204.

FIG. 5 is a block diagram representation of the search categories 502, according to one embodiment. Particularly, FIG. 5 illustrates a block 504, a type of advertisement 504A, a block 506, a property representation 508, and a block 510, according to one embodiment.

The block 504 may display various search categories 502 based on which the advertisements 212 are selected by the users 102 to be displayed along with the user profiles 204 in the geo-spatial environment 100. The type of advertisement 504A may be a search category 502 from which the users 102 of the geo-spatial environment 100 select desired advertisements 212 to display in conjunction with the user profiles 204. The block 506 may display various types of advertisements 212 that are available for the users 102 to select in order to associate them with the user profiles 204 in the geo-spatial environment 100 (e.g., using the availability module 306 of FIG. 3).

The property representation 508 may indicate a portion of a property where the desired advertisements 212 are displayed in the geo-spatial environment 100. The block 510 may display a list of the portion of the property available to place the advertisements 212 in the geo-spatial environment 100.

In the example embodiment illustrated in FIG. 5, the users 102 of the geo-spatial environment 100 may search for the desired advertisements 212 to be displayed along with the user profiles 204 based on the search categories 502. The search categories 502 include preference, location of a user profile and type of advertisement (e.g., displayed in the block 504). The type of advertisement 504A includes options for product, service, music clip, event, audiovisual clip, podcast, celebrity, etc. as displayed in the block 506.

The property representation 508 includes a representation of an outside surface of a structure (e.g., a building, in the geo-spatial environment 100) associated with the first user profile 204A, a representation of an inside area of a structure (e.g., an interior space) associated with the first user profile 204A, a representation of an outside property area associated with the first user profile 204A, a wiki associated with the first user profile 204A, and content associated with the wiki as shown in the block 510.

The search categories 502 associated with the advertisements 212 may be provided (e.g., using the search module 310 of FIG. 3) and/or a search category 502 may be selected (e.g., by a user 102). A third advertisement 212 associated with the search category 502 may be determined, and/or a third user profile 204 associated with the third advertisement 212 may be determined (e.g., using the advertisement module 110 and/or the additional modules 116 of FIG. 1). A third display view may be generated to include a three-dimensional map view (e.g., the three-dimensional map view 402 of FIG. 4) embodied by the community network 200, the third user profile 204 represented at a location in the three-dimensional map view 402 corresponding with the associated specific geographic location 206, and the third advertisement 212 displayed in conjunction with the third user profile 204.

The search categories 502 may include preference, location of a user profile, and/or type of advertisement (e.g., may be associated with a product, service, music clip, movie trailer, event, audiovisual clip, podcast, and/or celebrity). A link between the third advertisement 212 and a website may be generated, the link may be selected (e.g., by a user 102) and an online transaction associated with the third advertisement 212 may be processed. The online transaction may include generating an online purchase transaction associated with the product and/or the service in the geo-spatial environment 100. For example, the online transaction may include generating an online order of music associated with a music clip, generating an online order of a movie associated with a movie trailer, generating an online reservation associated with an event, and/or generating an online payment transaction associated with an online reservation. The online transaction may also include generating a link associated with a celebrity.

The geo-spatial environment 100 may include a sixth instruction set to provide the search categories 502, to enable selection of a search category 502, to determine an advertisement 212 associated with a selected search category 502, and/or to identify a user profile 204 associated with the advertisement 212.

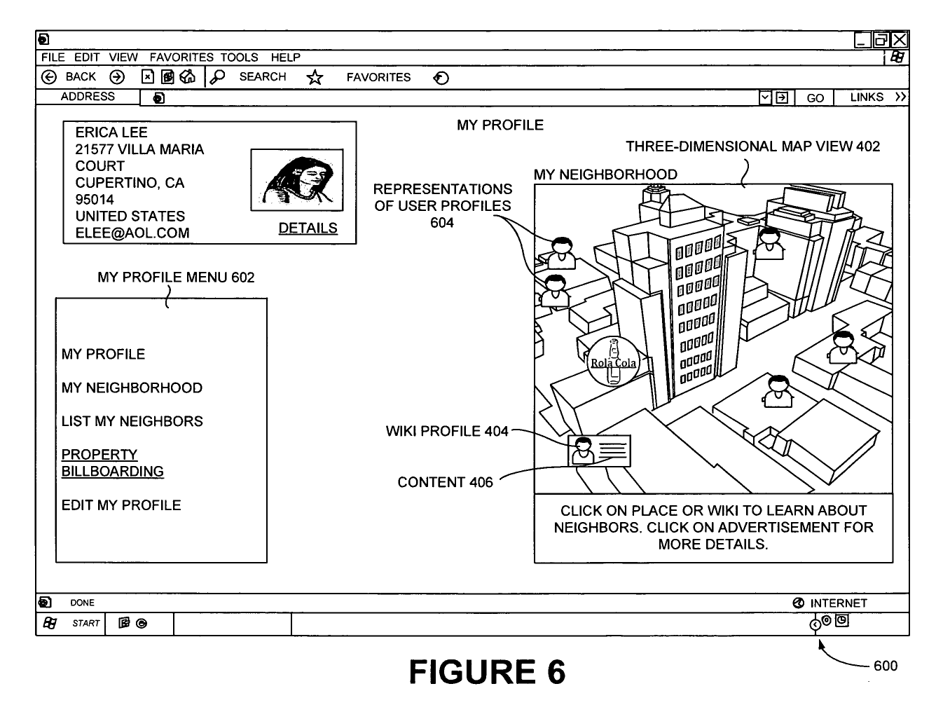

FIG. 6 is a user interface view 600 displaying profile details of a user 102 associated with the community network 200, according to one embodiment. Particularly, FIG. 6 illustrates the three-dimensional map view 402, the wiki profile 404, the content 406, my profile menu 602, and representations of user profiles 604, according to one embodiment.

The my profile menu 602 may display profile information associated with the user 102 in the geo-spatial environment 100 (e.g., biographical information, interests, preferences, group affiliations, hobbies, background, etc.). The representations of user profiles 604 may be the user profiles 204 and wiki profiles 404 (e.g., publicly editable profiles) that are displayed in the three-dimensional map view 402.

In the example embodiment illustrated in FIG. 6, the user interface view 600 displays profile information of the user (e.g., Erica Lee) in the my profile menu 602. The my profile menu 602 displays details of the neighborhood, property billboarding, etc. in the geo-spatial environment 100. The three-dimensional map view 402 displays the neighborhood of the user (e.g., Erica Lee) where the advertisements 212 are displayed.

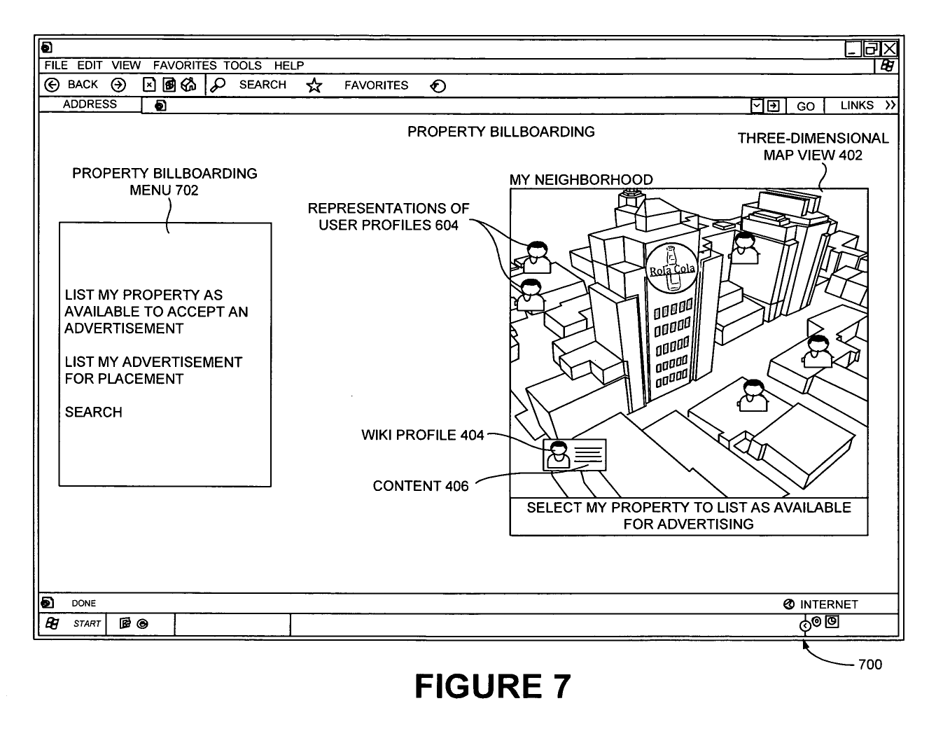

FIG. 7 is a user interface view 700 of property billboarding associated with a specific geographic location (e.g., the specific geographic location 206 illustrated in FIG. 2), according to one embodiment. Particularly, FIG. 7 illustrates the three-dimensional map view 402, the wiki profile 404, the content 406, the representations of user profile 604, and a property billboarding menu 702, according to one embodiment.

The property billboarding menu 702 may display options associated with placing of the advertisements 212 along with the user profiles 204 in the geo-spatial environment 100.

In the example embodiment illustrated in FIG. 7, the property billboarding menu 702 displays the options “list my property as available to accept an advertisement”, “list my advertisement for placement” and a search option. The user (e.g., Erica Lee) may offer her property (e.g., in the geo-spatial environment 100) for placement of the advertisements 212 (e.g., may offer property billboarding for the advertisements 212) and may also display any desired advertisements 212 in the geo-spatial environment 100. An example advertisement (e.g., Rola Cola) displayed along with the user profiles 204 and the wiki profile 404 is illustrated in the three-dimensional map view 402.

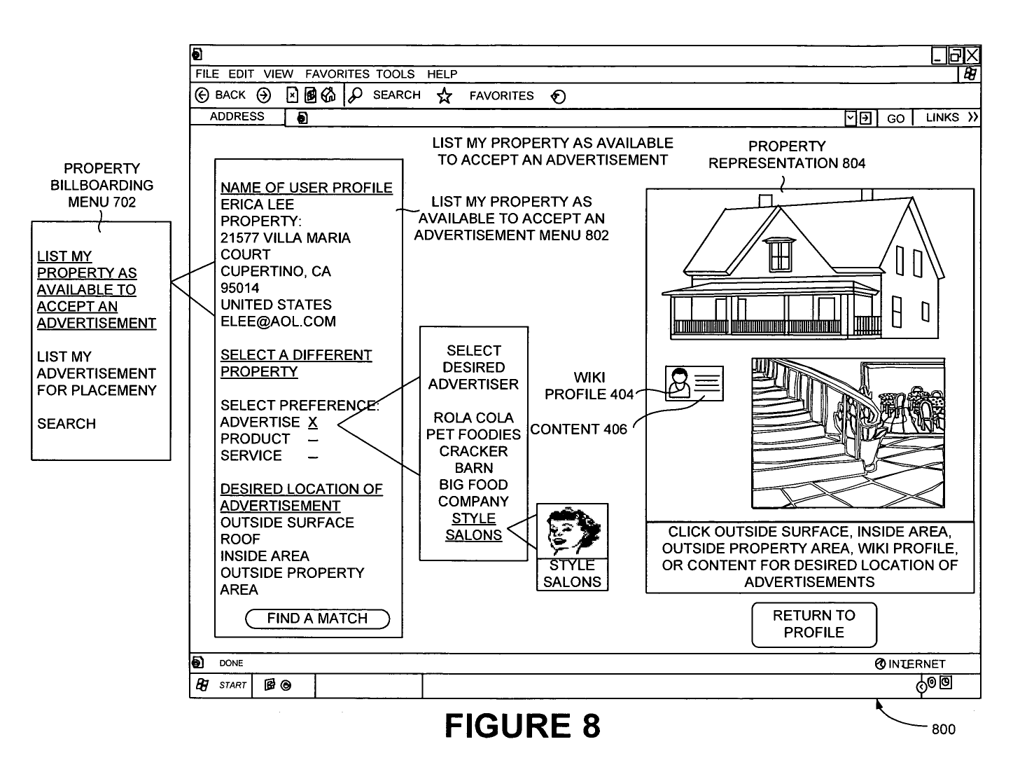

FIG. 8 is a user interface view 800 of listing property of the user 102 as available to accept an advertisement 212, according to one embodiment. Particularly, FIG. 8 illustrates wiki profile 404, the content 406, the property billboarding menu 702, a list my property as available to accept an advertisement menu 802, and a property representation 804, according to one embodiment.

The list my property as available to accept an advertisement menu 802 may display options that enable the user 102 to list his/her property (e.g., in the geo-spatial environment 100) as available to accept the advertisements 212 that are displayed along with the user profiles 204 in the geo-spatial environment 100. The property representation 804 may be representations of physical buildings and/or structures in the geo-spatial environment 100 where the advertisements 212 are displayed.

In the example embodiment illustrated in FIG. 8, the user interface view 800 displays location details of the user 102 (e.g., Erica Lee) in the list my property as available to accept an advertisement menu 802. The user 102 may select an advertisement (e.g., Style Salons) matching her preference (e.g., for advertiser, product and/or service). The user 102 may offer outside surface, inside area, and/or outside property area views associated with a property representation for displaying a matched advertisement 212 in the geo-spatial environment 100. The advertisements 212 may also be displayed along with the wiki profile 404 and the content 406 associated with the user 102.

The first advertisement 212 may be displayed in conjunction with the property representation, selected from a group (e.g., including a representation of an outside surface of a structure, a representation of an inside area of a structure, a representation of an outside property area, a wiki and/or content associated with the wiki) associated with the first user profile 204A.

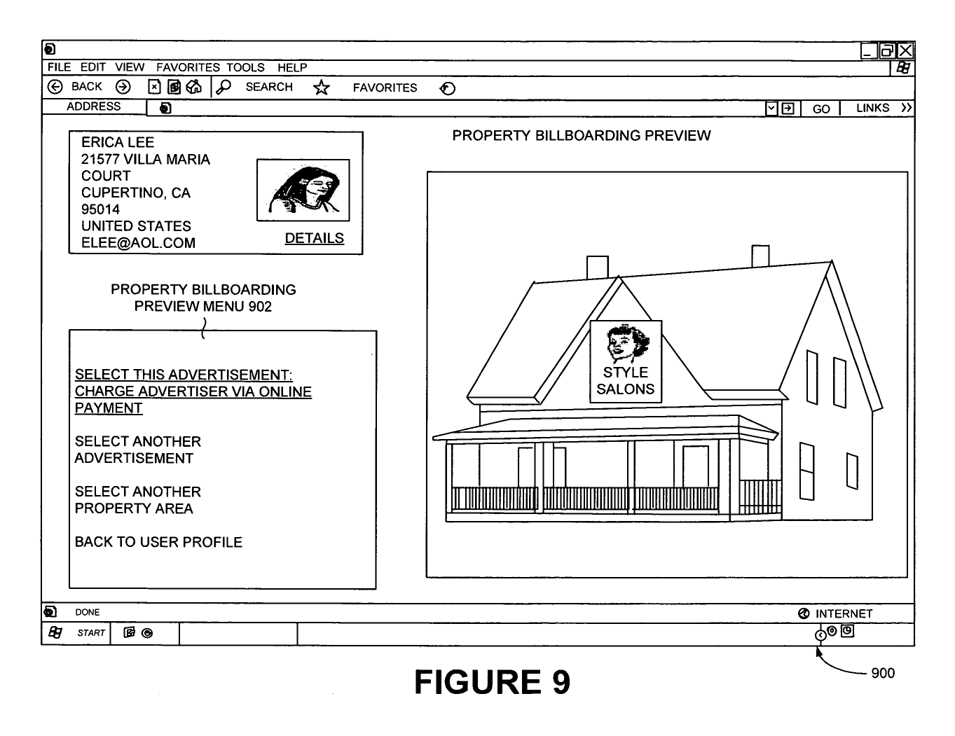

FIG. 9 is a user interface view 900 of the property billboarding preview, according to one embodiment. Particularly, FIG. 9 illustrates a property billboarding preview menu 902, according to one embodiment.

The property billboarding preview menu 902 may display options to confirm the placement of the desired advertisements 212 on a property area associated with the users 102 in the geo-spatial environment 100.

In the example embodiment illustrated in FIG. 9, the user interface view 900 displays the advertisement 212 (e.g., Style Salons) on outside surface of the property representation associated with the user 102 (e.g., Erica Lee) in the geo-spatial environment 100. The users 102 of the geo-spatial environment 100 may select another advertisement 212 and/or another property area based on their preferences (e.g., for advertisers, products and/or services). Online payments may also be performed during the property billboarding in the geo-spatial environment 100 (e.g., using the revenue module 302 of FIG. 3).

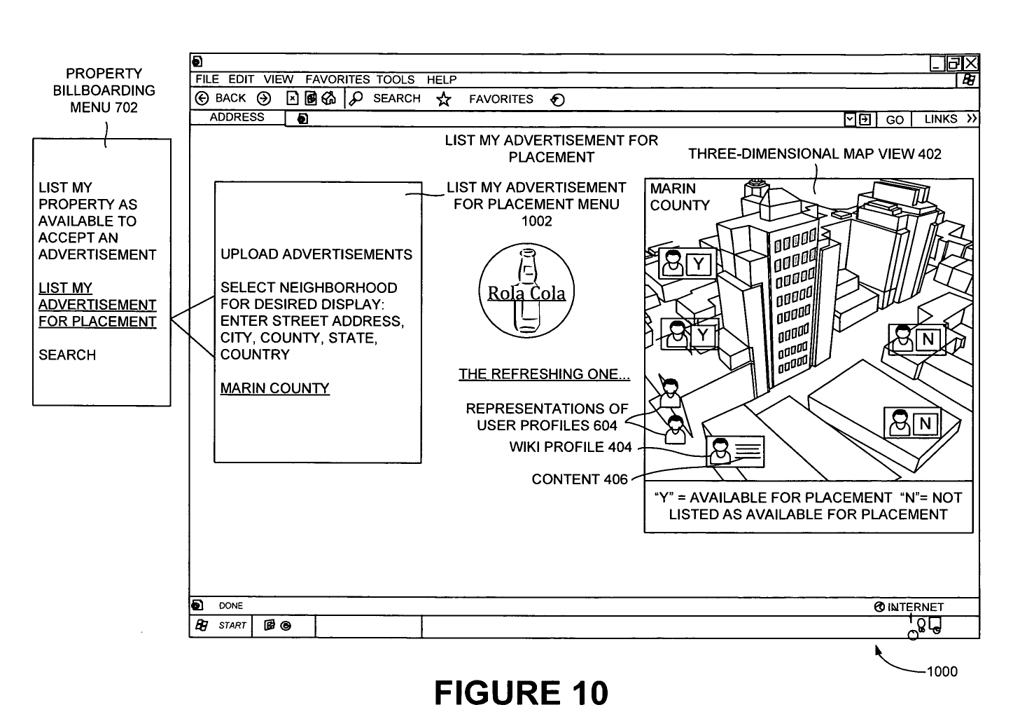

FIG. 10 is a user interface view 1000 of listing an advertisement 212 for placement in the geo-spatial environment 100, according to one embodiment. Particularly, FIG. 10 illustrates the three-dimensional map view 402, the wiki profile 404, the content 406, the representations of user profiles 604, the property billboarding menu 702, a list my advertisement for placement menu 1002, according to one embodiment.

The list my advertisement for placement menu 1002 may display options that enable an advertiser (e.g., may be a user 102) to display the advertisements 212 in the geo-spatial environment 100.

In the example embodiment illustrated in FIG. 10, the list my advertisement for placement menu 1002 displays various options including “upload advertisement” and “select neighborhood for desired display”. The advertiser may upload the advertisements 212 on desired property representations in the geo-spatial environment 100. The three-dimensional map view 402 displays a specific geographic location (e.g., Marin County) where the advertisement 212 (e.g., Rola Cola) is listed to be placed.

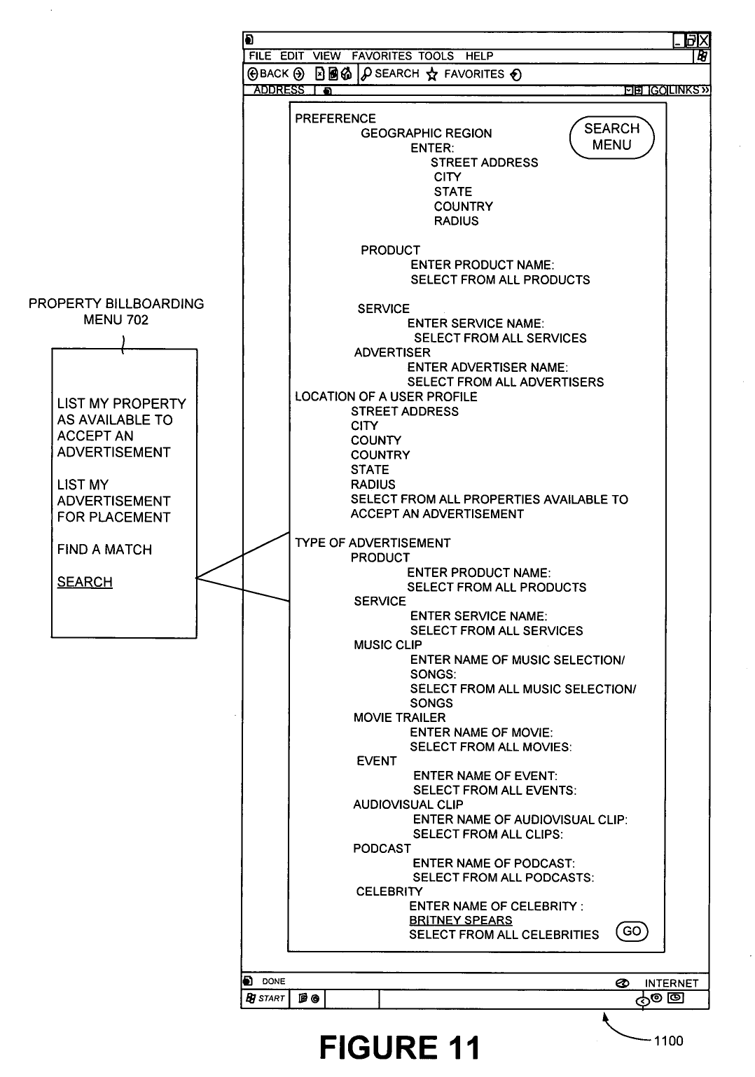

FIG. 11 is a user interface view 1100 of a search menu associated with the property billboarding (e.g., displaying an advertisement 212 in a specific geographic location 206 associated with a user profile 204 of the geospatial environment 100 based on a preference of a user 102 associated with the user profile 204), according to one embodiment. Particularly, FIG. 11 illustrates the property billboarding menu 702, according to one embodiment.

In the example embodiment illustrated in FIG. 11, the search menu displays the search categories 502 (e.g., the preference, the location of a user profile, type of advertisement, etc.) based on which the users 102 search for the desired advertisements 212 that are placed along with the user profiles 204 in the geo-spatial environment 100. The search category preference includes options such as geographic region, product, service and advertiser. The search category location of a user profile 204 includes street address, city, county, state, country, and radius (e.g., from a geospatial location associated with the user profile 204). The type of advertisement 212 includes options such as product, service, music clip, event, audiovisual clip, podcast, and celebrity. The users 102 may enter their preferences (e.g., Britney Spears in a celebrity link in the type of advertisement search category) to obtain the desired advertisements 212 in the geo-spatial environment 100.

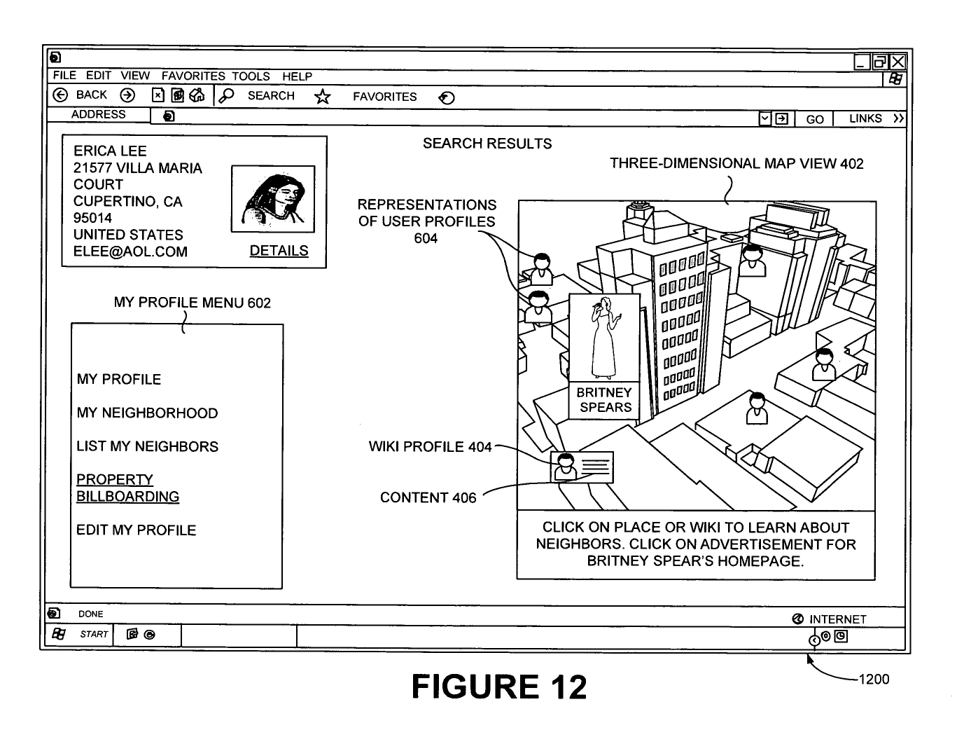

FIG. 12 is a user interface view 1200 displaying search results associated with the property billboarding, according to one embodiment. Particularly, FIG. 12 illustrates the three-dimensional map view 402, the wiki profile 404, the content 406, the my profile menu 602, and the representations of user profiles 604, according to one embodiment.

In the example embodiment illustrated in FIG. 12, the user interface view 1200 displays the search results when ‘Britney Spears’ is entered in the celebrity link in the type of advertisement search category. The users 102 of the geo-spatial environment 100 may click on the advertisement 212 to visualize Britney Spears' homepage. The advertisement 212 may be displayed along with the profile 204 of the user 102 (e.g., Erica Lee). The three-dimensional map view 402 also displays the user profiles 204 in the neighborhood.

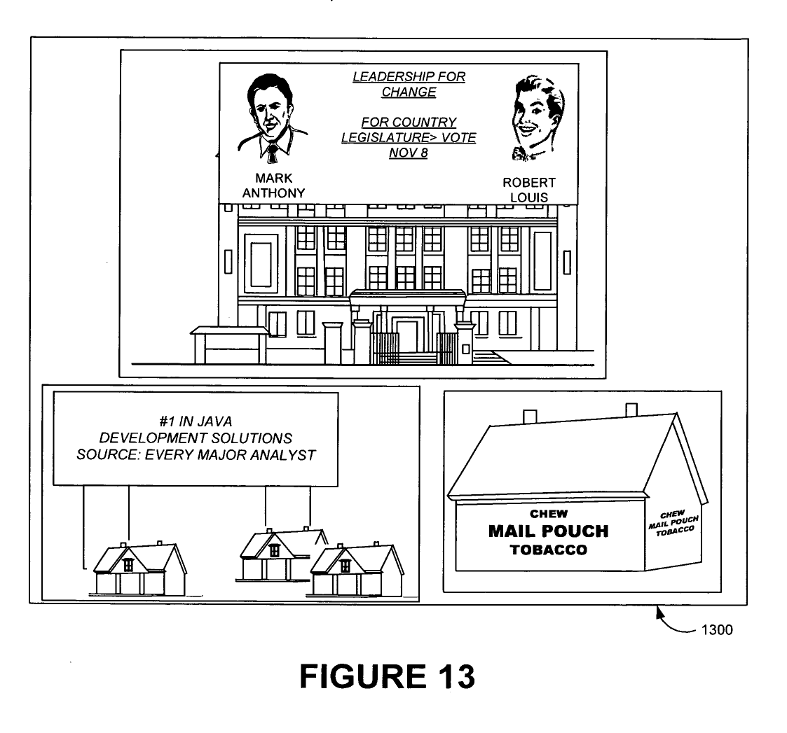

FIG. 13 is a representation of displayed advertisements 212, according to one embodiment. The advertisements 212 may be displayed on the buildings and/or the structures by advertisers (e.g., seeking to publicize and/or increase demand for their products and/or services). The advertisers may pay owners (e.g., users 102) of the buildings and/or the structures (e.g., through the revenue module 302 of FIG. 3) for displaying the advertisements 212 in specific geographic locations 206 associated with the user profiles 204 of the users 102 in the geo-spatial environment 100).

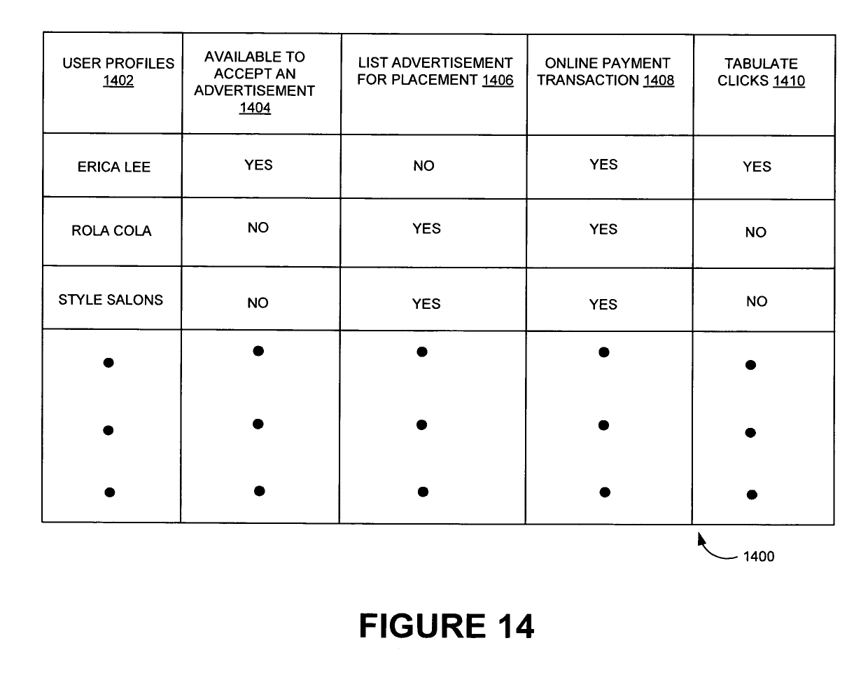

FIG. 14 is a table view 1400 displaying advertisement and commerce transaction information, according to one embodiment. Particularly, FIG. 14 illustrates a user profiles field 1402, an available to accept an advertisement field 1404, a list advertisement for placement field 1406, an online payment transaction field 1408, and a tabulate clicks field 1410, according to one embodiment.

The user profiles field 1402 may display an identifier (e.g., a name, a username, a unique key, etc.) associated with users 102 of the geo-spatial environment 100. The available to accept an advertisement field 1404 may indicate whether or not the users 102 are ready to accept any advertisements 212 to be displayed along with the user profiles 204 in the geo-spatial environment 100. The list advertisement for placement field 1406 may indicate whether or not the user profiles 204 have any advertisements 212 to be placed along with other user profiles 204 in the geo-spatial environment 100.

The online payment transaction field 1408 may indicate whether or not facilities for online payment transaction are available for the commerce transaction associated with the advertisements 212. The tabulate clicks field 1410 may indicate whether or not clicks of a link associated with an advertisement 212 are tabulated (e.g., by the tabulate module 304 of FIG. 3).

In the example embodiment illustrated in FIG. 14, the user profiles field 1402 displays “Erica Lee” in the first row, “Rola Cola” in the second row and “Style Salons” in the third row of the user profiles field column 1402. The available to accept an advertisement field 1404 displays “Yes” in the first row, “No” in the second row and “No” in the third row of the available to accept an advertisement field column 1404 (e.g., Erica Lee is available to accept the advertisements 212 while Rola Cola and Style Salons are not available to accept any advertisements 212 in the geo-spatial environment 100). The list advertisement for placement field 1406 displays “No” in the first row, “Yes” in the second row and “Yes” in the third row of the list advertisement for placement field column 1406 (e.g., Erica Lee has no advertisement 212 to be placed while Rola Cola and Style Salons do have advertisements 212 listed to be placed in the geo-spatial environment 100). The online payment transaction field 1408 displays “Yes” in the first row, “Yes” in the second row and “Yes” in the third row of the online payment transaction field column 1408 (e.g., online payment transaction options for the advertisements 212 are associated and/or activated with Erica Lee, Rola Cola and Style Salons). The tabulate clicks field 1410 displays “Yes” in the first row, “No” in the second row and “No” in the third row of the tabulate clicks field column 1410 (e.g., clicks of the link associated with the advertisement 212 for Erica Lee are tabulated while no clicks associated with advertisements 212 of Rola Cola and Style Salons are tabulated).

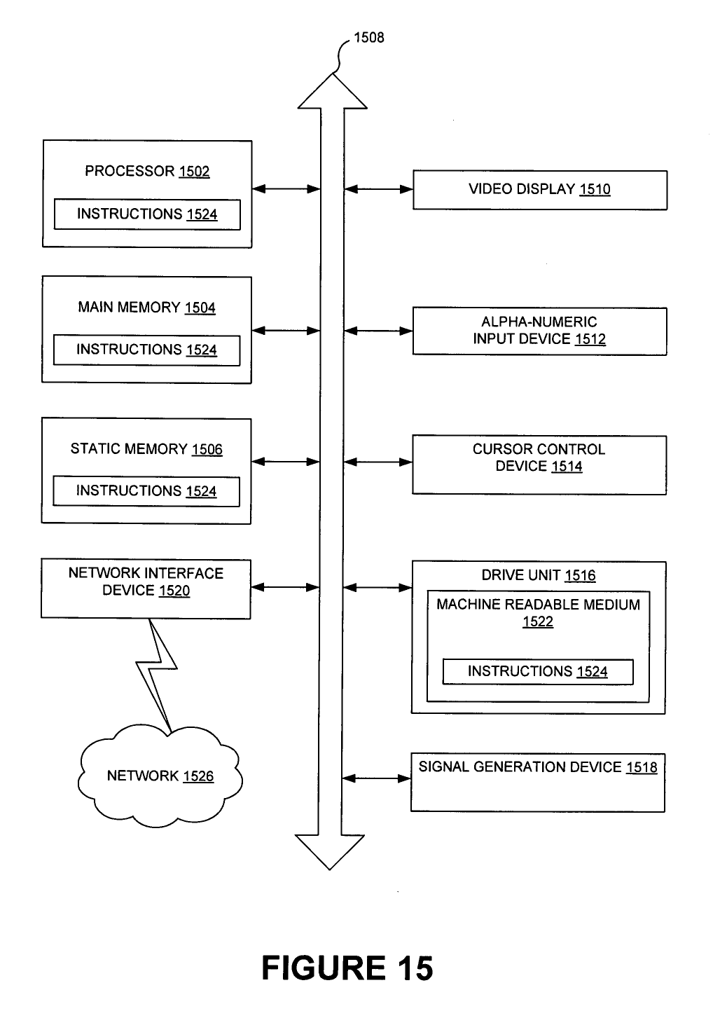

FIG. 15 is a diagrammatic system view 1500 of a data processing system in which any of the embodiments disclosed herein may be performed, according to one embodiment. Particularly, the diagrammatic system view 1500 of FIG. 15 illustrates a processor 1502, a main memory 1504, a static memory 1506, a bus 1508, a video display 1510, an alpha-numeric input device 1512, a cursor control device 1514, a drive unit 1516, a signal generation device 1518, a network interface device 1520, a machine readable medium 1522, instructions 1524, and a network 1526, according to one embodiment.

The diagrammatic system view 1500 may indicate a personal computer and/or the data processing system in which one or more operations disclosed herein are performed. The processor 1502 may be a microprocessor, a state machine, an application specific integrated circuit, a field programmable gate array, etc. (e.g., Intel® Pentium® processor). The main memory 1504 may be a dynamic random access memory and/or a primary memory of a computer system.

The static memory 1506 may be a hard drive, a flash drive, and/or other memory information associated with the data processing system. The bus 1508 may be an interconnection between various circuits and/or structures of the data processing system. The video display 1510 may provide graphical representation of information on the data processing system. The alpha-numeric input device 1512 may be a keypad, a keyboard and/or any other input device of text (e.g., a special device to aid the physically handicapped).

The cursor control device 1514 may be a pointing device such as a mouse. The drive unit 1516 may be the hard drive, a storage system, and/or other longer term storage subsystem. The signal generation device 1518 may be a bios and/or a functional operating system of the data processing system. The network interface device 1520 may be a device that performs interface functions such as code conversion, protocol conversion and/or buffering required for communication to and from the network 1526. The machine readable medium 1522 may provide instructions on which any of the methods disclosed herein may be performed. The instructions 1524 may provide source code and/or data code to the processor 1502 to enable any one or more operations disclosed herein.

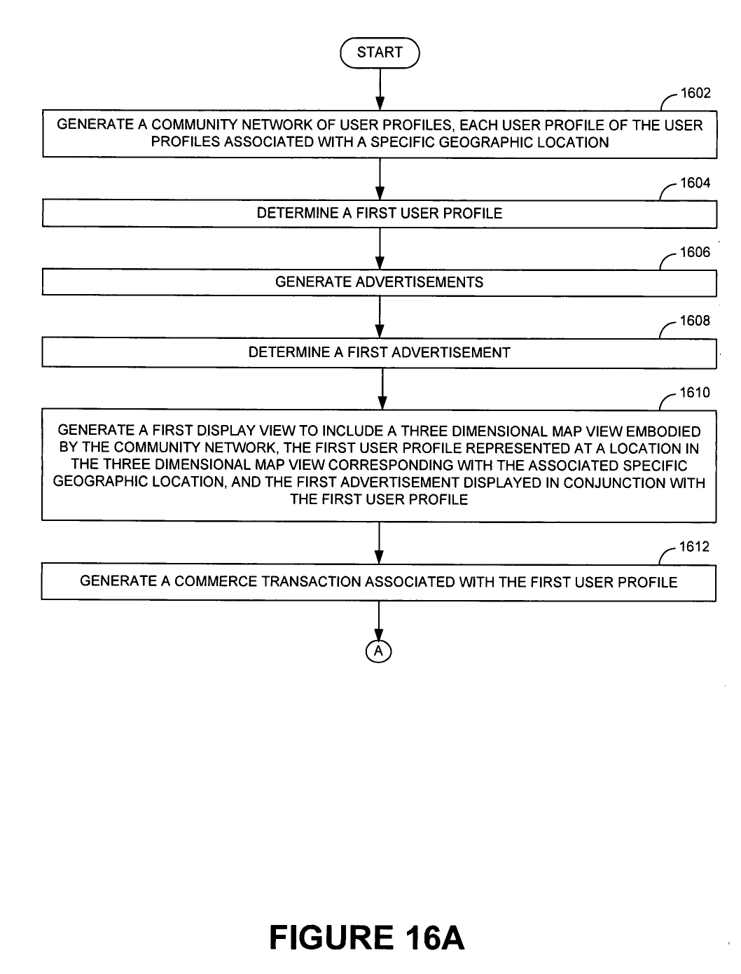

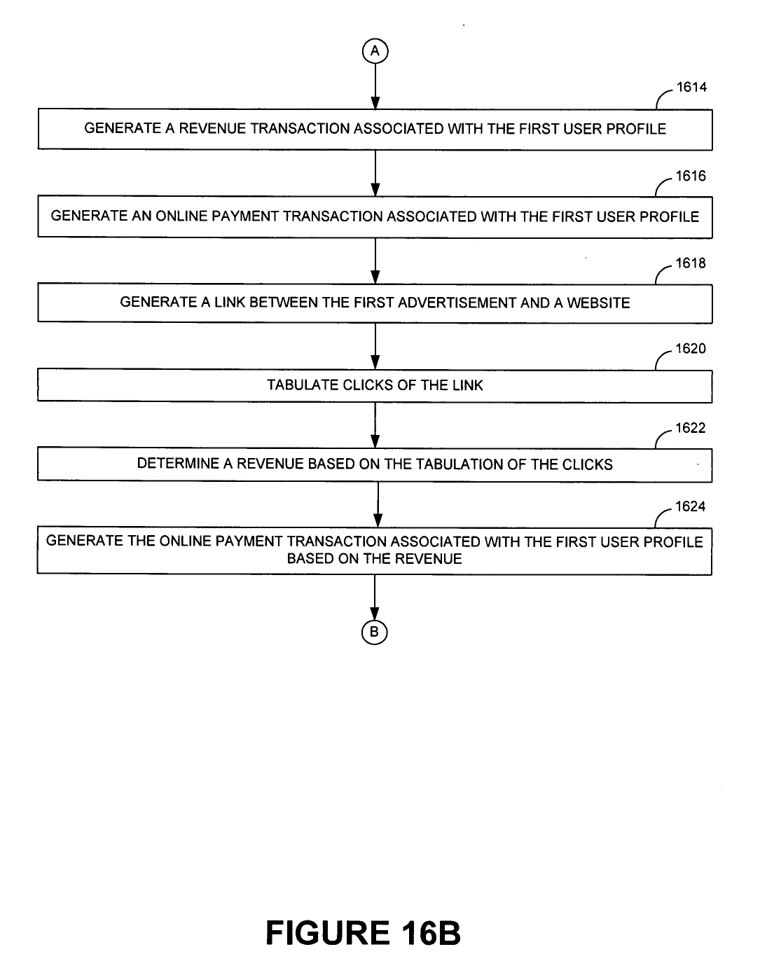

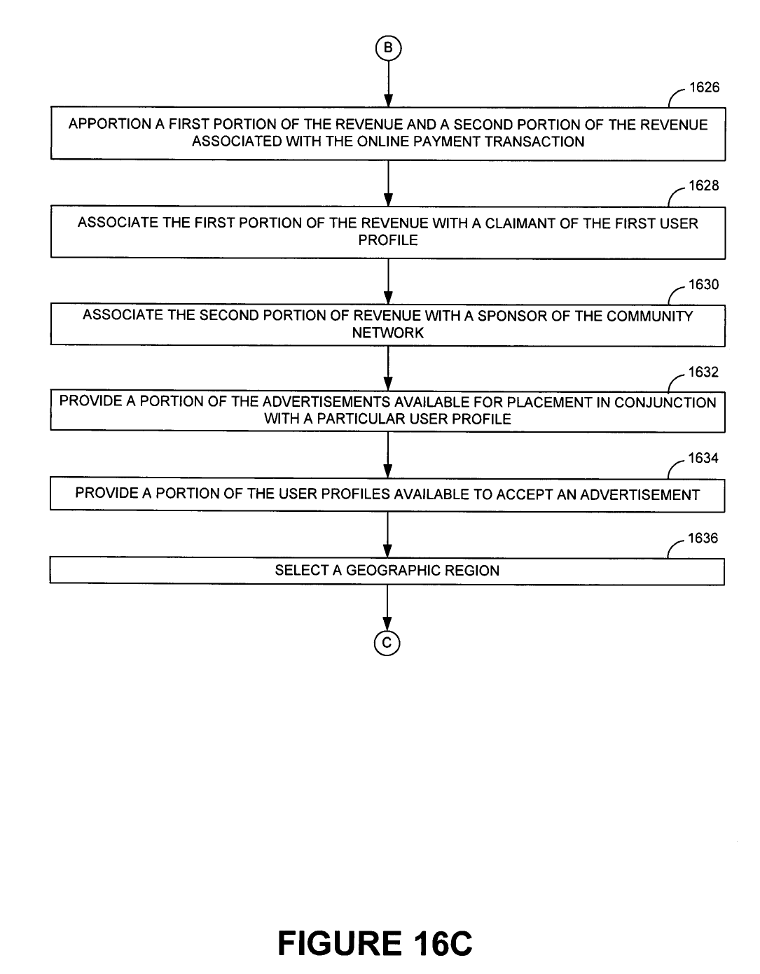

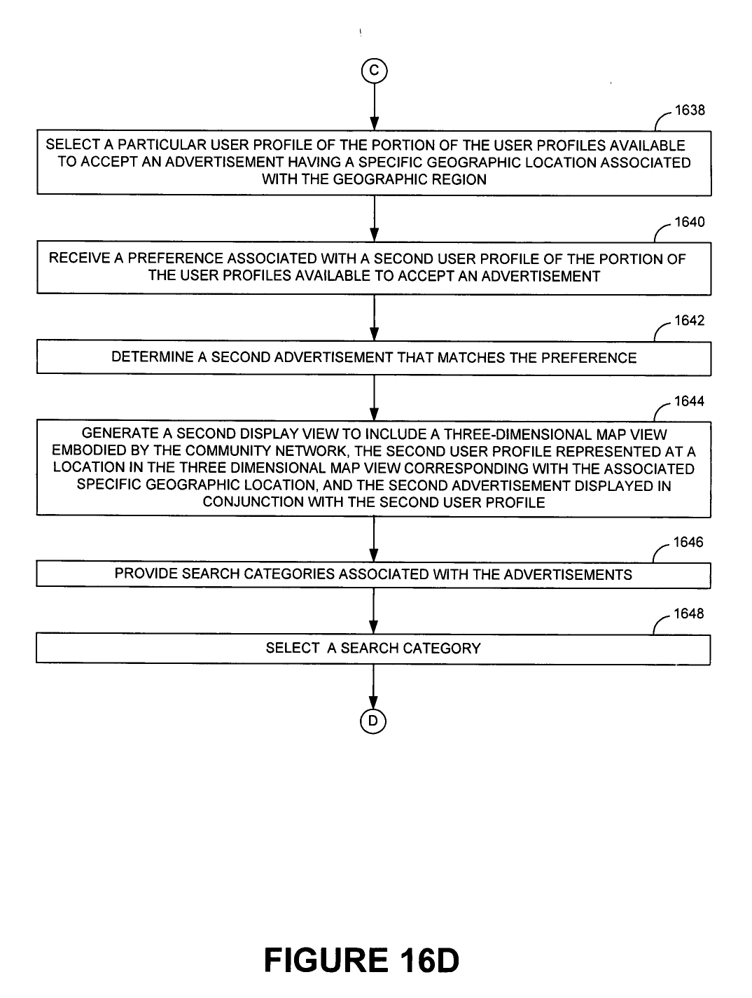

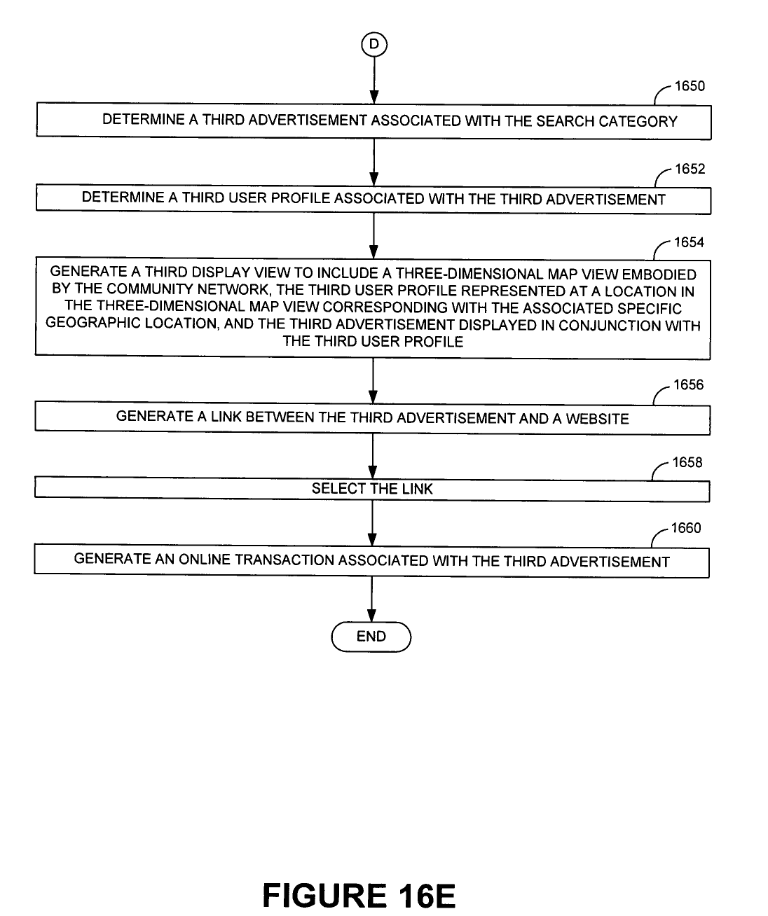

FIG. 16A is a process flow of generating, placing and commerce transaction associated with advertisements 212 in a geo-spatial environment 100, according to one embodiment. In operation 1602, a community network (e.g., the community network 200 of FIG. 2) of user profiles (e.g., the user profiles 204 of FIG. 2) may be generated, in which each user profile 204 is associated with a specific geographic location (e.g., the specific geographic location 206 of FIG. 2). In operation 1604, a first user profile (e.g., the first user profile 204A of FIG. 4) may be determined. In operation 1606, advertisements 212 may be generated (e.g., using the advertisement module 110 of FIG. 1). In operation 1608, a first advertisement 212 may be determined.

In operation 1610, a first display view (e.g., the display view 400 of FIG. 4) may be generated to include a three-dimensional map view (e.g., the three-dimensional map view 402 of FIG. 4) embodied by the community network 200, the first user profile 204A represented at a location in the three-dimensional map view 402 corresponding with the associated specific geographic location 206, and the first advertisement 212A displayed in conjunction with the first user profile 204A. In operation 1612, a commerce transaction associated with the first user profile 204A may be generated (e.g., using the commerce transaction module 114 of FIG. 1).

FIG. 16B is a continuation of the process flow of FIG. 16A, showing additional processes, according to one embodiment. In operation 1614, a revenue transaction associated with the first user profile 204A may be generated (e.g., using the revenue module 302 of FIG. 3). In operation 1616, an online payment transaction associated with the first user profile 204A may be generated (e.g., using the online payment module 302A of FIG. 3). In operation 1618, a link between the first advertisement 212A and a website may be generated (e.g., using the advertisement module 110 of FIG. 1).

In operation 1620, clicks of the link may be tabulated (e.g., using the tabulate module 304 of FIG. 3). In operation 1622, a revenue may be determined based on the tabulation of the clicks (e.g., using the revenue module 302 of FIG. 3). In operation 1624, the online payment transaction associated with the first user profile 204A may be generated (e.g., using the online payment module 302A of FIG. 3) based on the revenue.

FIG. 16C is a continuation of the process flow of FIG. 16B, showing additional processes, according to one embodiment. In operation 1626, a first portion of the revenue and a second portion of the revenue associated with the online payment transaction may be apportioned (e.g., using the revenue module 302 of FIG. 3). In operation 1628, the first portion of the revenue may be associated with a claimant of the first user profile 204A. In operation 1630, the second portion of the revenue may be associated with a sponsor of the community network 200.

In operation 1632, a portion of the advertisements 212 available for placement in conjunction with a particular user profile 204 may be provided (e.g., by the advertisement module 110 of FIG. 1). In operation 1634, a portion of the user profiles 204 available to accept an advertisement 212 may be provided (e.g., through the availability module 306 of FIG. 3). In operation 1636, a geographic region (e.g., in the geo-spatial environment 100) may be selected.

FIG. 16D is a continuation of the process flow of FIG. 16C, showing additional processes, according to one embodiment. In operation 1638, a particular user profile 204 of the portion of the user profiles 204 available to accept an advertisement 212 having a specific geographic location 206 associated with the geographic region may be selected. In operation 1640, a preference associated with a second user profile 204 of the portion of the user profiles 204 available to accept an advertisement 212 may be received (e.g., through the preference module 308 of FIG. 3). In operation 1642, a second advertisement 212 that matches the preference may be determined (e.g., using the advertisement module 110 of FIG. 1).

In operation 1644, a second display view may be generated (e.g., using the display module 112 of FIG. 1) to include a three-dimensional map view 402 embodied by the community network 200, the second user profile 204 represented at a location in the three-dimensional map view 402 corresponding with the associated specific geographic location 206, and the second advertisement 212 displayed in conjunction with the second user profile 204. In operation 1646, search categories 502 associated with the advertisements 212 may be provided (e.g., through the search module 310 of FIG. 3). In operation 1648, a search category 502 may be selected.

FIG. 16E is a continuation of the process flow of FIG. 16D, showing additional processes, according to one embodiment. In operation 1650, a third advertisement 212 associated with the search category 502 may be determined (e.g., using the advertisement module 110 of FIG. 1). In operation 1652, a third user profile 204 associated with the third advertisement 212 may be determined.

In operation 1654, a third display view may be generated to include a three-dimensional map view (e.g., the three-dimensional map view 402 of FIG. 4) embodied by the community network 200, the third user profile 204 represented at a location in the three-dimensional map view 402 corresponding with the associated specific geographic location 206, and the third advertisement 212 displayed in conjunction with the third user profile 204. In operation 1656, a link between the third advertisement 212 and a website may be generated (e.g., using the tabulate module 304 of FIG. 3). In operation 1658, the link may be selected. In operation 1660, an online transaction associated with the third advertisement 212 may be generated (e.g., using the online payment module 302A of FIG. 3).

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structures and methods may be embodied using transistors, logic gates, and electrical circuits (e.g., Application Specific Integrated (ASIC) Circuitry and/or in Digital Signal Processor (DSP) circuitry).

For example, the community network module 106, the map module 108, the advertisement module 110, the display module 112, the commerce transaction module 114, the additional modules 116, the revenue module 302, the online payment module 302A, the tabulate module 304, the availability module 306, the preference module 308, the search module 310, the wiki profile module 312, the append module 314 and other modules of FIGS. 1-13 may be enabled using a community network circuit, a map circuit, an advertisement circuit, a display circuit, a commerce transaction circuit, additional circuit, a revenue circuit, an online payment transaction circuit, a tabulate circuit, an availability circuit, a preference circuit, a search circuit, a wiki profile circuit, an append circuit and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method, comprising:
generating a community network of user profiles, each user profile of the user profiles associated with a specific geographic location;
determining a first user profile of the user profiles;
generating advertisements;
determining a first advertisement of the advertisements;
generating a first display view to include a three-dimensional map view embodied by the community network, the first user profile of the user profiles represented at a location in the three-dimensional map view corresponding with the associated specific geographic location, and the first advertisement of the advertisements displayed in conjunction with the first user profile of the user profiles; and
generating a commerce transaction associated with the first user profile of the user profiles.

2. The method of claim 1, further comprising generating a revenue transaction associated with the first user profile of the user profiles.

3. The method of claim 2, further comprising generating an online payment transaction associated with the first user profile of the user profiles.

4. The method of claim 3, further comprising:
generating a link between the first advertisement and a website;
tabulating clicks of the link;
determining revenue based on the tabulation of the clicks; and
generating the online payment transaction associated with the first user profile of the user profiles based on the revenue.

5. The method of claim 4, further comprising:
apportioning a first portion of the revenue and a second portion of the revenue associated with the online payment transaction;
associating the first portion of the revenue with a claimant of the first user profile of the user profiles; and
associating the second portion of the revenue with a sponsor of the community network.

6. The method of claim 1, further comprising providing at least a portion of the advertisements available for placement in conjunction with a particular user profile of the user profiles.

7. The method of claim 6, further comprising providing at least a portion of the user profiles available to accept an advertisement.

8. The method of claim 7, further comprising:
selecting a geographic region; and
selecting a particular user profile of the at least a portion of the user profiles available to accept an advertisement having a specific geographic location associated with the geographic region.

9. The method of claim 8, further comprising:
receiving a preference associated with a second user profile of the at least a portion of the user profiles available to accept an advertisement;
determining a second advertisement of the advertisements that matches the preference; and
generating a second display view to include a three-dimensional map view embodied by the community network, the second user profile of the user profiles represented at a location in the three-dimensional map view corresponding with the associated specific geographic location, and the second advertisement of the advertisements displayed in conjunction with the second user profile of the user profiles.

10. The method of claim 9, wherein the preference includes an advertiser, a product, and a service.

11. The method of claim 1, further comprising:
providing search categories associated with the advertisements;
selecting at least one search category of the search categories;
determining a third advertisement of the advertisements associated with the at least one search category;
determining a third user profile of the user profiles associated with the third advertisement; and
generating a third display view to include a three-dimensional map view embodied by the community network, the third user profile of the user profiles represented at a location in the three-dimensional map view corresponding with the associated specific geographic location, and the third advertisement of the advertisements displayed in conjunction with the third user profile of the user profiles.

12. The method of claim 11, wherein the search categories include a preference, a location of a user profile, and a type of advertisement.

13. The method of claim 12, wherein the type of advertisement is associated with at least one of a product, a service, a music clip, a movie trailer, an event, an audiovisual clip, a podcast, and a celebrity.

14. The method of claim 11, further comprising:
generating a link between the third advertisement and a website;
selecting the link; and
generating an online transaction associated with the third advertisement.

15. The method of claim 14, wherein the online transaction further comprises generating an online purchase transaction associated with the product and the service.

16. The method of claim 14, wherein the online transaction further comprises generating an online order of music associated with the music clip.

17. The method of claim 14, wherein the online transaction further comprises generating an online order of a movie associated with the movie trailer.

18. The method of claim 14, wherein the online transaction further comprises:
generating an online reservation associated with the event; and
generating an online payment transaction associated with the online reservation.

19. The method of claim 14, wherein the online transaction further comprises generating a link associated with the celebrity.

20. The method of claim 1, wherein the first advertisement is displayed in conjunction with a property representation selected from a group comprising a representation of an outside surface of a structure associated with the first user profile, a representation of an inside area of a structure associated with the first user profile, a representation of an outside property area associated with the first user profile, a wiki associated with the first user profile, and content associated with the wiki.

21. The method of claim 1 in a form of a machine-readable medium embodying a set of instructions that, when executed by a machine, causes the machine to perform the method of claim 1.

22. A system, comprising:
a geo-spatial environment;
a community network module of the geo-spatial environment, to include user profiles, each user profile of the user profiles to include a specific geographic location;
an advertisement module of the geo-spatial environment to generate advertisements;
a map module of the geo-spatial environment to include map data which serve as a basis to render a three-dimensional map view in the geo-spatial environment which identifies at least some of residences, businesses, and civic structures having specific geographic locations;
a display module of the geo-spatial environment to generate a first display view of the three-dimensional map view embodied by a community network, a first user profile of the user profiles represented at a location in the three-dimensional map view corresponding to the specific geographic location associated with the first user profile, and an advertisement of the advertisements displayed in conjunction with the first user profile of the user profiles; and
a commerce transaction module of the geo-spatial environment to generate a commerce transaction associated with the first user profile.

23. The system of claim 22, further comprising a revenue module of the geo-spatial environment to generate revenue associated with the commerce transaction.

24. The system of claim 23, further comprising an online payment transaction module of the geo-spatial environment to generate an online payment transaction associated with the revenue.

25. The system of claim 24, wherein a first portion of the revenue is associated with a claimant of the first user profile and a second portion of the revenue is associated with a sponsor of the community network.

26. The system of claim 22, further comprising a tabulate module of the geo-spatial environment to generate a link associated with the first advertisement, to tabulate clicks of the link, and to associate the tabulated links with the commerce transaction.

27. The system of claim 22, further comprising an availability module of the geo-spatial environment to provide at least a portion of the user profiles available to accept the advertisements and to enable selection of a particular user profile of the at least a portion of user profiles with which a particular advertisement of the advertisements is associated.

28. The system of claim 22, further comprising a preference module of the geo-spatial environment to determine a second user profile available to accept an advertisement, to receive a preference associated with the second user profile available to accept an advertisement, and to determine a particular advertisement of the advertisements that matches the preference.

29. The system of claim 28, wherein the preference includes an advertiser, a product, and a service.

30. The system of claim 22, further comprising a search module of the geo-spatial environment to provide search categories, to enable selection of at least one search category of the search categories, to determine at least one advertisement associated with a selected at least one search category, and to identify at least one user profile of the user profiles associated with the at least one advertisement.

31. The system of claim 30, wherein the search categories include a preference, a location of a user profile, and a type of advertisement.

32. The system of claim 22, further comprising a wiki profile module of the geo-spatial environment to generate a wiki profile associated with at least one representation of a user profile.

33. The system of claim 22, comprising an append module of the geo-spatial environment to generate with the wiki profile, content associated with the wiki profile.

34. A geo-spatial environment, comprising:
a first instruction set to enable a community network, to include a map database associated with map data, a user database associated with user profiles, each user profile of the user profiles associated with a specific geographic location identifiable in the map data, and an advertisement database associated with advertisements, each advertisement of the advertisements associated with a user profile of the user profiles;
a second instruction set integrated with the first instruction set to display a three-dimensional map view embodied by the community network, a user profile of the user profiles represented at a location in the three-dimensional map view corresponding to the associated specific geographic location, and an advertisement associated with the user profile of the user profiles; and
a third instruction set to generate a commerce transaction associated with the user profile.

35. The geo-spatial environment of claim 34, further comprising a fourth instruction set to generate an online payment transaction associated with the user profile of the user profiles.

36. The geo-spatial environment of claim 34, further comprising a fifth instruction set to provide at least a portion of the user profiles available to accept an advertisement.

37. The geo-spatial environment of claim 34, further comprising a sixth instruction set to provide search categories, to enable selection of at least one search category of the search categories, to determine at least one advertisement associated with a selected at least one search category, and to identify at least one user profile of the user profiles associated with the at least one advertisement.
